(19) United States
(12) Patent Application Publication
(10) Pub. No.: US 2017/0308448 A1
(43) Pub. Date: Oct. 26, 2017

(54) TERMINAL APPARATUS AND FAILURE RESPONSE CONTROL METHOD

(71) Applicant: FUJITSU LIMITED, Kawasaki-shi (JP)

(72) Inventor: Yukihiro SATO, Kawasaki (JP)

(73) Assignee: FUJITSU LIMITED, Kawasaki-shi (JP)

(21) Appl. No.: 15/469,514

(22) Filed: Mar. 25, 2017

(30) Foreign Application Priority Data
Apr. 26, 2016 (JP) 2016-088621

(51) Int. Cl. G06F 11/20; G06F 3/06

(52) U.S. Cl. CPC G06F 11/2094; G06F 3/0679; G06F 3/0647; G06F 3/0619; G06F 3/0637; G06F 3/064

(57) ABSTRACT

A terminal apparatus includes a memory that has a program area divided in a plurality of blocks, each blocks being set write protection, and a processor coupled to the memory and configured to set a priority level of stored data to each blocks of the memory, respectively, change the priority level to a lower level in accordance with a failure of an internal of the terminal apparatus when the failure is detected, release the write protection in accordance with the changed priority level, and write data that has a possibility of elimination, to the block whose write protection has released, in accordance with the failure.

### CROSS-REFERENCE TO RELATED APPLICATION

This application is based upon and claims the benefit of priority of the prior Japanese Patent Application No. 2016-088621, filed on Apr. 26, 2016, the entire contents of which are incorporated herein by reference.

### FIELD

The embodiments discussed herein are related to a terminal apparatus and a failure response control method.

### BACKGROUND

In recent years, Internet of Things (IoT) links various terminal apparatuses to a network, and thus the number of installations of terminal apparatuses is rapidly on the rise. In IoT, terminal apparatuses are sometimes requested to operate in unattended situations, such as data collection in remote areas, and the like. In such cases, the terminal apparatuses are requested to have a small number of maintenance operations and to have a strong resilience to failure. Techniques are provided in order to continue operation of the terminal apparatuses even if a failure occurs in part of the terminal apparatuses by having redundancy in a main device and an internal memory that are included in the terminal apparatuses.

As the related art, the following techniques are provided. For example, in one of the techniques, when data is recorded in a memory, the data is recorded with information indicating the importance level or the oldness of the data, and write protection is set for the data. After that, a user releases the write protection of the data having the importance level that has decreased or old data (for example, refer to Japanese Laid-open Patent Publication No. 7-281937). Also, for example, in another technique, it is possible to optionally set a protection area in which writing data is inhibited in a random access memory (RAM), and when writing is performed in the protection area, control is performed by giving write permission to the area (for example, refer to Japanese Laid-open Patent Publication No. 5-20202).

### SUMMARY

According to an aspect of the invention, a terminal apparatus includes a memory that has a program area divided in a plurality of blocks, each blocks being set write protection, and a processor coupled to the memory and configured to set a priority level of stored data to each blocks of the memory, respectively, change the priority level to a lower level in accordance with a failure of an internal of the terminal apparatus when the failure is detected, release the write protection in accordance with the changed priority level, and write data that has a possibility of elimination, to the block whose write protection has released, in accordance with the failure.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of operation by a terminal apparatus according to the present disclosure;

FIG. 2 is an explanatory diagram illustrating an example of a system;

FIG. 3 is a block diagram illustrating an example of a hardware configuration of a sensor module;

FIG. 4 is an explanatory diagram illustrating an example of memory mapping information of a nonvolatile memory;

FIG. 5 is an explanatory diagram illustrating a detailed example of a failure determination circuit;

FIG. 6 is an explanatory diagram (1 of 3) illustrating an example of a change in write protection control and storage contents;

FIG. 7 is an explanatory diagram (2 of 3) illustrating an example of a change in write protection control and storage contents;

FIG. 8 is an explanatory diagram (3 of 3) illustrating an example of a change in write protection control and storage contents;

FIG. 9 is a sequence chart (1 of 2) illustrating an example of a processing procedure of write protection release by the sensor module;

FIG. 10 is a sequence chart (2 of 2) illustrating an example of a processing procedure of write protection release by the sensor module; and

FIG. 11 is a sequence chart illustrating an example of a failure determination processing procedure by a radio device and a failure determination circuit.

### DESCRIPTION OF EMBODIMENTS

With the related art technique, if a failure occurs in a terminal apparatus, data to be written into a memory is sometimes lost. For example, if a radio device in a terminal apparatus fails while data is being temporarily stored in a memory before transmission by the radio device to a network is completed, the transmission of the data to the network fails, and the data area of the memory becomes full. As a result, the data to be written is sometimes lost.

As one aspect of the present disclosure, it is desirable to provide a terminal apparatus, a failure response control program, and a failure response control method that are capable of reducing the probability of losing data to be written.

In the following, a detailed description will be given of a terminal apparatus, a failure response control program, and a failure response control method according to embodiments of the present disclosure with reference to the accompanying drawings.

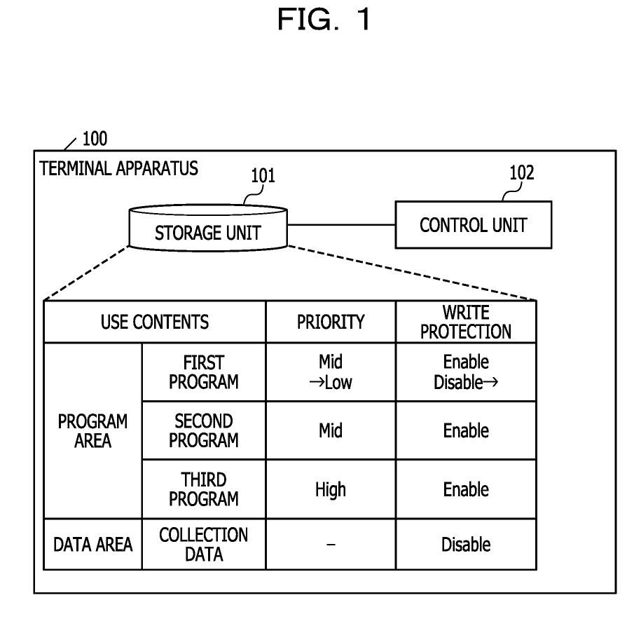

FIG. 1 is an explanatory diagram illustrating an example of an operation by a terminal apparatus according to the present disclosure. A terminal apparatus 100 is a computer capable of expanding a data area when a failure occurs. Here, the terminal apparatus 100 stores data to be written into the data area. However, the memory capacity of the terminal apparatus 100 has a limitation.

With the related art technique, if a failure occurs in the terminal apparatus 100, data to be written into a storage area is sometimes lost. For example, it is thought that in the terminal apparatus 100, when data collected by a sensor is transmitted to a network by a radio device, the data is temporarily stored in a nonvolatile memory, or the like. In such a case, if a failure occurs in the radio device, it is not possible for the data to be transmitted to the network so that the storage area in the memory becomes full, and thus the data to be written is sometimes lost.

Here, as described above, techniques are provided in order to design a nonvolatile memory so as to have redundancy, or the like under the assumption that a part of the terminal apparatus 100 might fail. However, if a part of the terminal apparatus 100 is designed so as to have redundancy, the price increases, and the size of the terminal apparatus 100 increases. Also, the terminal apparatus 100, or the like is often a small-sized apparatus, and is driven by a battery, or the like. Accordingly, if the nonvolatile memory is designed so as to have redundancy, the power consumption increases, and thus the probability of the occurrence of a battery shortage, or the like increases.

Thus, in the present embodiment, in the terminal apparatus 100, an importance level is set to each data item in a write-protected program area, and the importance level is changed based on a detected failure and the importance level set in advance. Based on the importance level after the change, the data write protection of an area is released. It is possible to write data to be written in the data area where the write protection has been released, and thus to reduce the probability of losing the data to be written.

The terminal apparatus 100 includes, for example a storage unit 101 and a control unit 102. The storage unit 101 is, for example a nonvolatile memory. The control unit 102 is, for example a central processing unit. The area of the storage unit 101 is roughly divided into, for example a program area capable of storing various kinds of program data and a data area capable of storing data to be written.

The control unit 102 sets the importance level of write protection of a partial area storing data for each of a plurality of data items that are stored in the program area. Here, the importance level is indicated by a numeric value, a character string, or the like, and the number of levels is not particularly limited. An importance level is also referred to as a priority. In the example in FIG. 1, the priority is indicated by three levels, namely “High”, “Mid”, and “Low”. Also, a plurality of data items is program data.

Here, the priority of data that is not deleted even if a failure occurs in a part related to the data is set to “High”. The priority of data that is deletable if a failure occurs in a part related to the data is set to “Mid”. The priority of data that is to be deleted if a failure occurs in a part related to the data is set to “Low”.

In the example in FIG. 1, the control unit 102 sets the priorities of a first program and a second program to “Mid”, and sets the priority of a third program to “High”. The first program is, for example a program regarding communication. The second program is, for example, a program regarding an interface. The third program is, for example, a program for controlling the entire system.

Also, the program area is write protected in advance. Here, it is assumed that write protection is capable of being set, for example, for each block of the program area. Accordingly, it is assumed that each data in the program area is stored in the program area such that the data is capable of being separated for each block, for example. “Enable” denotes that the data is write protected, and “Disable” denotes that the data is not write protected. For example, “Enable” is set for write protection from the first program to the third program.

If a failure is detected in the terminal apparatus 100, the control unit 102 changes the priority based on the detected failure and the set priority. The control unit 102 lowers the priority of the program regarding a failed part, for example.

For example, if a failure occurs in a communication unit, or the like, the control unit 102 makes a change so as to lower the priority of the first program. Also, for example, if a failure occurs in an interface, or the like, the control unit 102 makes a change so as to lower the priority of the second program. Also, for example, if the priority of the data corresponding to a failure is “High”, the control unit 102 does not change the priority. In the example in FIG. 1, the control unit 102 lowers the priority of the first program from “Mid” to “Low”.

The control unit 102 then releases the write protection of the partial area where data based on the priority after the change is stored among a plurality of data items. The control unit 102 releases the write protection of the partial area where the first program whose priority after the change is “Low”. Thereby, it is possible to write data to be written in the partial area where the write protection has been released. The control unit 102 instructs the storage unit 101 to delete the data stored in the partial area after the release, for example. The control unit 102 then sets the deleted partial area to an area capable of storing data to be written. Thereby, it is possible to reduce the probability of losing data to be written.

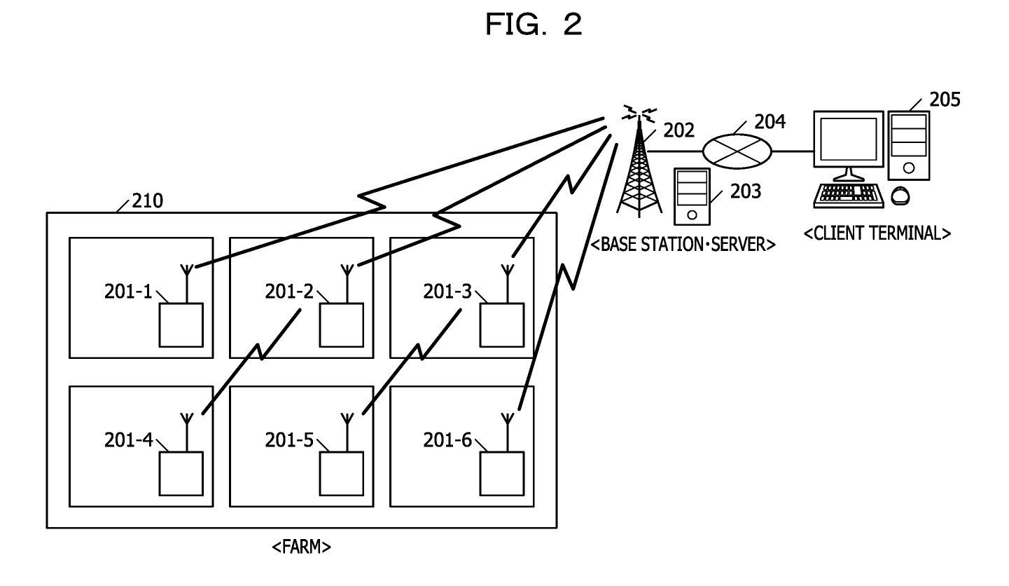

FIG. 2 is an explanatory diagram illustrating an example of a system. A system 200 includes, for example a plurality of sensor modules 201, a base station 202, a server 203, and a client terminal apparatus 205.

Each of a plurality of sensor modules 201-1 to 201-6 is, for example the above-described terminal apparatus 100. The plurality of sensor modules 201-1 to 201-6 are disposed at various locations in a farm 210, for example. In the present embodiment, a description will be given of the case where the sensor modules 201 are disposed in the farm 210. However, the sensor modules 201 may be disposed at various places, such as in a house, on a road, on a cliff, underwater, or the like, and the location is not particularly limited. Each of the plurality of sensor modules 201-1 to 201-6 stores data having been subjected to sensing at the corresponding installation place, and transmits data to the base station 202 and the server 203 at each timing. The timing at which the data is transmitted may be changed depending on the monitoring contents of the farm 210, for example, per day or per hour, and is not particularly limited.

The base station 202 and the server 203 transmit data obtained from each of the plurality of sensor modules 201-1 to 201-6 to the client terminal apparatus 205 via a network 204. The client terminal apparatus 205 then, for example manages and operates the obtained data so as to monitor the state of the farm 210.

Also, the client terminal apparatus 205 maintains, for example, data obtained in a time series for each sensor module 201 so as to make it possible to identify a sensor module 201 that has not received data, or the like. Thereby, it is possible for the client terminal apparatus 205 to detect a sensor module 201 in which a failure of transmission of the data has occurred. Also, it is possible for the client terminal apparatus 205 to identify a sensor module 201 having abnormal data by comparing data of the plurality of sensor module 201-1 to 201-6, for example. Thereby, it is possible for the client terminal apparatus 205 to detect a sensor module 201 in which a failure with abnormal data has occurred.

### Example of Hardware Configuration of Sensor Module 201

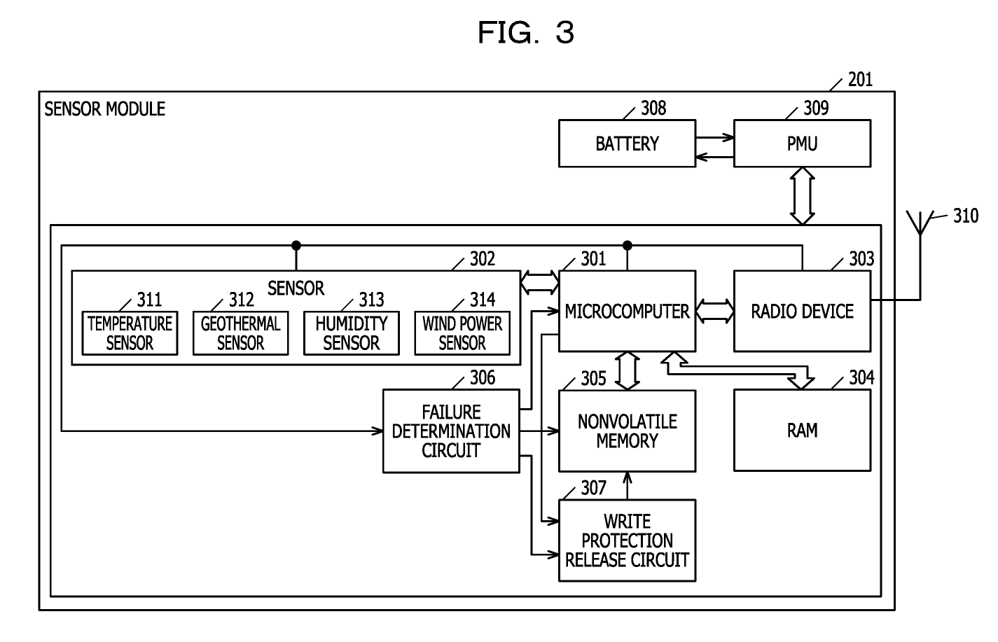

FIG. 3 is a block diagram illustrating an example of a hardware configuration of a sensor module. The sensor module 201 includes a microcomputer 301, various sensors 302, a radio device 303, a RAM 304, a nonvolatile memory 305, and a failure determination circuit 306. The sensor module 201 includes a write protection release circuit 307, a battery 308, a power management unit (PMU) 309, and an antenna 310.

The microcomputer 301 is a control unit 102 that performs, for example the entire control of the sensor module 201 and data processing. Specifically, the microcomputer 301 loads a program stored in the nonvolatile memory 305 into the RAM 304 and executes the program so as to perform the entire control and data processing. For example, the microcomputer 301 processes the data that has been subjected to sensing by the sensor 302.

The various sensors 302 are detection units that detect the amounts of change in predetermined fields at an installation location. For the sensors 302, for example, a temperature sensor 311 that detects ambient temperature at the installation location, a geothermal sensor 312 that detects geothermal heat at the installation location, a humidity sensor 313 that detects humidity at the installation location, a wind power sensor 314 that detects wind power at the installation location, and the like are given. Although not illustrated in FIG. 3, a pressure sensor, a photoelectric sensor, and the like may be used for the sensors 302.

The radio device 303 is, for example a communication unit. The radio device 303 is a radio frequency (RF) device, or the like. For example, the radio device 303 outputs a radio wave received via the antenna 310 as a reception signal, and transmits a transmission signal as a radio wave via the antenna 310. The antenna 310 transmits and receives radio waves for the radio communication with the base station 202, the server 203, the other sensor modules 201, and the like. The RAM 304 stores temporary data for the processing by the microcomputer 301.

The nonvolatile memory 305 is, for example a storage unit 101. The nonvolatile memory 305 is a writable memory and holds certain written data when power supply is stopped, or the like. An example of the nonvolatile memory 305 is a flash memory. The nonvolatile memory 305 has a function of write protection. The nonvolatile memory 305 makes it possible to determine whether or not to set write protection for each area in accordance with the signal from the write protection release circuit 307. When the nonvolatile memory 305 is a NAND-type flash memory, for example if the write protection becomes “Enable”, the operation of an internal high-voltage generation circuit is reset, and write and delete operations for the nonvolatile memory 305 are inhibited.

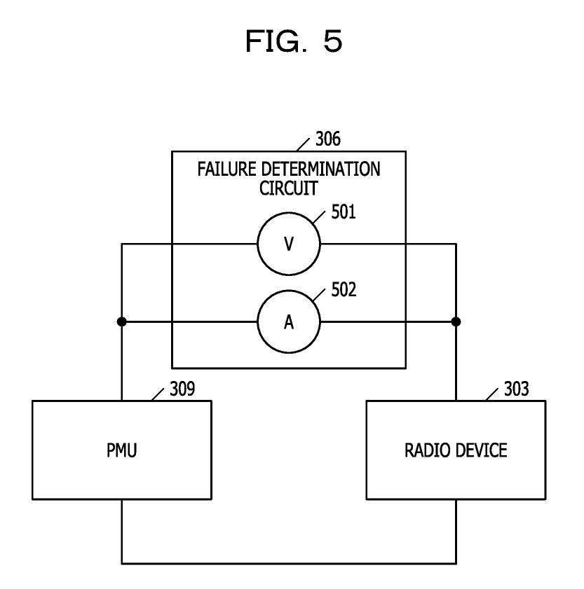

The failure determination circuit 306 is a failure determination unit that detects a failure in each unit, namely the microcomputer 301, the sensors 302, the radio device 303, and the like. As described later, the failure determination circuit 306 may detect a failure based on a current value and a voltage value of each unit. A description will be given later of a simple example of the failure determination circuit 306 for detecting a failure in the radio device 303 based on a current value and a voltage value with reference to FIG. 5. Also, the failure determination circuit 306 may detect a failure in the radio device 303 depending on, for example the communication state of the radio device 303. The failure determination circuit 306 may detect a failure in the sensors 302 in response to the sensing data of the sensors 302, for example.

The write protection release circuit 307 outputs a release signal for controlling “Disable” or “Enable” of write protection for each area of the nonvolatile memory 305 in response to, for example an instruction from the microcomputer 301. When for example, the write protection release circuit 307 sets write protection for an area of the nonvolatile memory 305 to “Disable”, the write protection release circuit 307 sets the release signal to “OFF”, whereas when the write protection release circuit 307 sets write protection for an area of the nonvolatile memory 305 to “Enable”, the write protection release circuit 307 sets the release signal to “ON”.

The battery 308 stores electric power for operating the sensor module 201. The PMU 309 performs control for supplying electric power stored in the battery 308 to each unit of the sensor module 201 as driving power.

Also, although not illustrated in FIG. 3, the sensor module 201 may include a harvester, and the like. A harvester performs power generation based on a change in energy in the external environment, for example light, vibration, temperature, radio waves (received radio waves), and the like of the sensor module 201 at an installation location. The harvester may generate power in accordance with the variation detected by the sensor 302.

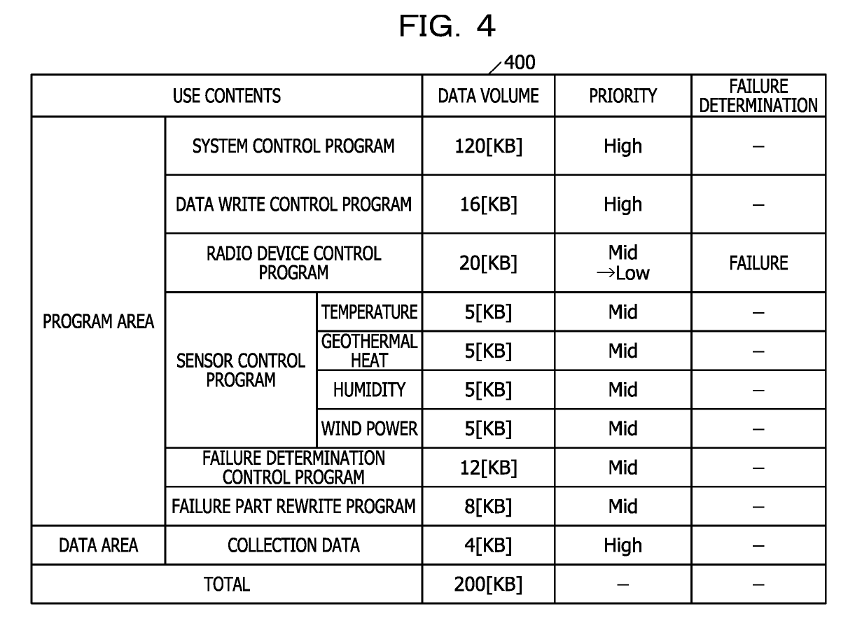

FIG. 4 is an explanatory diagram illustrating an example of memory mapping information of the nonvolatile memory. Memory mapping information 400 is information that indicates, for example, a data volume, a priority, and a failure determination for each area. Although not illustrated in FIG. 4, the memory mapping information 400 is information illustrating an address mapping relationship between the physical address space and the logical address space in the nonvolatile memory 305. The memory mapping information 400 is stored in a predetermined area, for example the beginning of the nonvolatile memory 305, or the like.

The data volume is the size of data stored in each area. The priority of the program area is the importance level of write protection. The priority of the data area is the importance level of data. As described above, the priority is indicated by “High”, “Mid”, and “Low”.

According to the memory mapping information 400, the total data volume of the nonvolatile memory 305 is 200 [KB]. The nonvolatile memory 305 includes a program area and a data area. The program area stores various programs. The data area stores collection data.

First, the program area stores a system control program, a data write control program, a radio device control program, a sensor control program, a failure determination control program, a failure rewrite program, and the like. The microcomputer 301 reads each program stored in the nonvolatile memory 305 in accordance with various use contents and executes the processing coded in each program. The failure response control program according to the present disclosure is realized by programs, such as the system control program, the failure determination control program, the failure rewrite program, and the like.

The system control program is a program that controls the entire sensor module 201. The data volume of the system control program is 120 [KB]. Also, the priority of the system control program is set to “High” in advance.

The data write control program is a program that writes the data detected by the various sensors 302 in each area in sequence. The data volume of the data write control program is 16 [KB]. Also, the priority of the data write control program is set to “High” in advance.

The radio device control program is a program that controls communication by the radio device 303. The data volume of the radio device control program is 20 [KB]. The priority of the radio device control program is set to “Mid” in advance.

The sensor control program is provided for each sensor 302 and is a program that controls the sensor 302. The data volume of each sensor control program is 5 [KB]. The priority of the sensor control program is set to “Mid” at normal time. For example, the sensor control program obtains sensing data from the sensor 302 and stores the obtained data in the data area as collection data. Also, the sensor control program, for example obtains sensing data from the sensor 302, compares the obtained data with a threshold value, and stores the comparison result as the collection data.

The failure determination control program is a program that controls determination of a failure of each component, such as the radio device 303, or the like. The data volume of the failure determination control program is 12 [KB]. The priority of the failure determination control program is set to “Mid” in advance.

The failure rewrite program is a program that changes the priority in the memory mapping information 400, or the like when a failure occurs. The data volume of the failure rewrite program is 8 [KB]. The priority of the failure rewrite program is set to “Mid” in advance.

The data area stores data to be written. Data to be written is obtained data from the outside, for example, and is not particularly limited. Here, data to be written is data based on the data having been subjected to sensing, for example. Data based on the data having been subjected to sensing by the various sensors 302 may be, for example, data that has been sensed, or a comparison result between the sensed data and a threshold value, or the difference value between the sensed data and a threshold value, or the like. Here, it is assumed that data that has been sensed is data to be written. Here, data to be written is also referred to as collection data. The data volume of the data area is 4 [KB]. The priority of the collection data is set to “High” in advance.

FIG. 5 is an explanatory diagram illustrating a detailed example of a failure determination circuit. The failure determination circuit 306 includes a voltmeter 501 and an ammeter 502. The voltmeter 501 and the ammeter 502 are disposed on the power line that is supplied from the PMU 309 to the radio device 303. Thereby, the failure determination circuit 306 is capable of monitoring a voltage value that is applied to the radio device 303 and a current value that is consumed by the, radio device 303.

The failure determination circuit 306 determines whether or not a voltage value and a current value that are measured by the voltmeter 501 and the ammeter 502 are in their respective predetermined ranges when the radio device 303 is started. The predetermined ranges are fixed in advance, for example, and are stored in a buffer, or the like in the failure determination circuit 306. For example, if the failure determination circuit 306 determines that the voltage value and the current value are both in their respective predetermined ranges, the radio device 303 transmits data to the base station 202, the server 203, or the like.

Also, the failure determination circuit 306 determines whether or not a voltage value and a current value that are measured by the voltmeter 501 and the ammeter 502 are in their respective predetermined ranges when the radio device 303 transmits data.

Here, if the failure determination circuit 306 determines that the voltage value and the current value are both in their respective predetermined ranges, the failure determination circuit 306 determines that a failure has not occurred. On the other hand, if the failure determination circuit 306 determines that either the voltage value or the current value is not in its respective predetermined range, the failure determination circuit 306 determines that a failure has occurred. For example, if the radio device 303 has failed in a short circuit mode, the voltage drops and the current consumption increases. Accordingly, if at least either one of the voltage value and the current value is higher than its respective predetermined range, the failure determination circuit 306 determines that a failure has occurred. Also, if the radio device 303 has failed in a release mode or by non-operation, the radio device 303 enters a state in which no current flows. Accordingly, if at least either one of the voltage value and the current value is lower than its respective predetermined range, the failure determination circuit 306 determines that a failure has occurred.

Also, for example if the radio device 303 fails to receive a response from the base station 202 or the server 203, the failure determination circuit 306 determines that the radio device 303 has failed.

Also, the failure determination circuit 306 may determine whether or not the various sensors 302 have failed by determining whether or not the sensing data are within respective predetermined ranges. Also, the failure determination circuit 306 may determine whether or not the various sensors 302 have failed by using an ammeter, a voltmeter, or the like in the same manner as the radio device 303.

For example, it is assumed that the predetermined range for the temperature sensor 311 is between “−10 degrees Celsius” and “40 degrees Celsius”. If the ambient temperature detected by the temperature sensor 311 is “−40 degrees Celsius”, the detected ambient temperature is not between “0 degrees Celsius” and “40 degrees Celsius”, and thus the failure determination circuit 306 determines that the temperature sensor 311 has failed.

Next, when a failure in the sensor module 201 is detected, the microcomputer 301 changes the priority of the program in accordance with a failed part. Here, changing the priority refers to notifying the nonvolatile memory 305 of a write request by the microcomputer 301 for changing the priority.

Also, for example when the microcomputer 301 changes a priority, the microcomputer 301 may change the priority after checking the priority of the current state of the program in accordance with the notified failed part. For example, if the priority of the program in accordance with a failed part is “High”, the microcomputer 301 will not change the priority. If the priority of the program in accordance with a failed part is “Mid”, the microcomputer 301 changes the priority to “Low”.

Alternatively, the microcomputer 301 may notify the nonvolatile memory 305 of a write request for changing the priority of the program in accordance with a failed part to “Low” without checking the priority of the current state. If the priority is “High”, the nonvolatile memory 305 may not make a write request in response to the write request, and if the priority is “Low”, the nonvolatile memory 305 may make a write request in response to the write request.

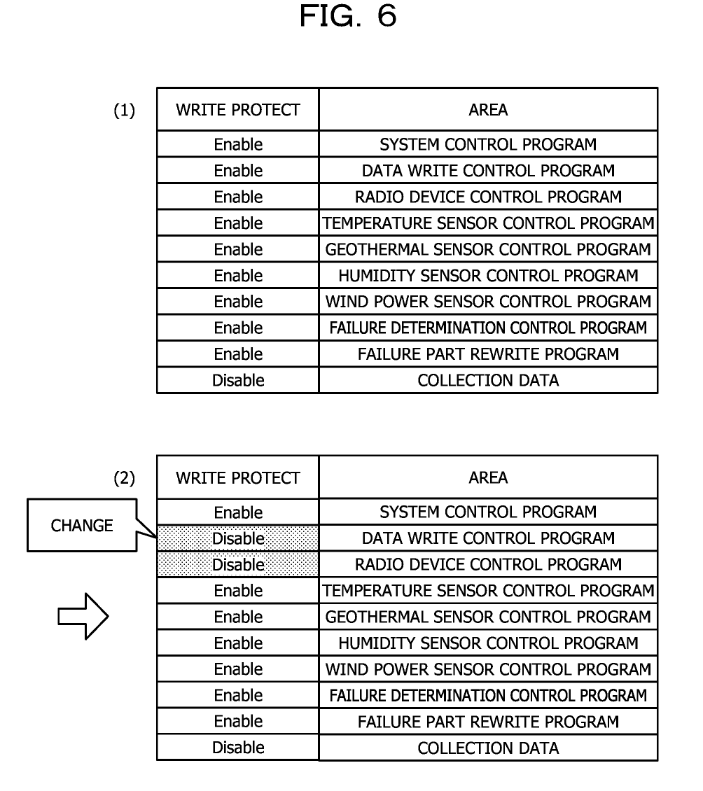

Here, a description will be given of an example in which a notification that the radio device 303 has failed is received from the failure determination circuit 306. In the example in FIG. 6, the microcomputer 301 refers to the memory mapping information 400 and changes the priority of the radio device control program regarding the radio device 303 from “Mid” to “Low”. For example, when the radio device 303 has failed, the microcomputer 301 may change not only the priority of the radio device control program, but also the priority of the failure determination control program from “Mid” to “Low”.

Also, for example, the failure determination circuit 306 may notify the microcomputer 301 of an instruction for changing the priority of the radio device control program in the memory mapping information 400, and the microcomputer 301 may change the priority in accordance with the instruction.

FIG. 6 is an explanatory diagram (1 of 3) illustrating an example of a change in write protection control and storage contents. As illustrated in FIG. 6 (1), all of the write protection of the program areas are “Enable”, and the write protection of the collection data area is “Disable”.

Here, when the microcomputer 301 receives a notification that the radio device 303 has failed from the failure determination circuit 306, the microcomputer 301 reads and executes the failure rewrite program. The microcomputer 301 then instructs the write protection release circuit 307 to release the write protection of the radio device control program and the data write control program corresponding to the radio device 303 having a failed part using the failure rewrite program.

Thereby, as illustrated in FIG. 6(2), the write protection of the radio device control program and the data write control program are changed from “Enable” to “Disable”.

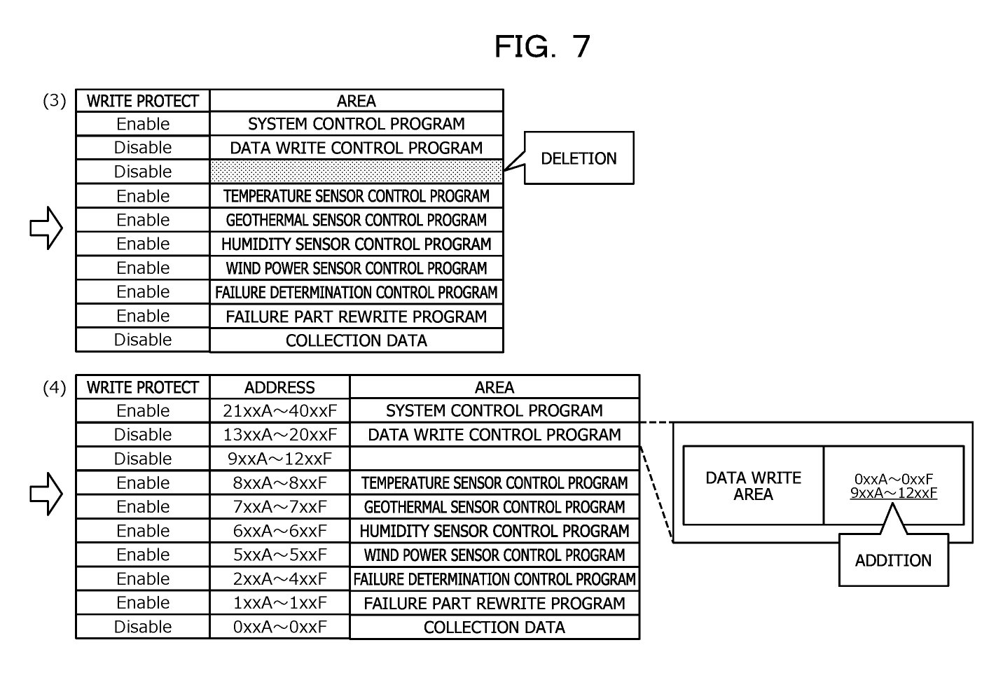

FIG. 7 is an explanatory diagram (2 of 3) illustrating an example of a change in write protection control and storage contents. Next, the microcomputer 301 instructs the nonvolatile memory 305 to release the area in which the radio device control program is stored using the failure rewrite program.

Thereby, as illustrated in FIG. 7(3), the nonvolatile memory 305 deletes the radio device control program.

The microcomputer 301 then changes the data write area described in the data write control program such that the area in which the radio device control program is stored becomes the storage area of collection data using the failure rewrite program.

As illustrated in FIG. 7(4), the addresses indicating the data write area described in the data write control program were addresses of “0xxA to 0xxF”. However, addresses of “9xxA to 12xxF” that indicate the area in which the radio device control program was stored is added.

Thereby, when the microcomputer 301 executes the data write control program, it becomes possible for the area in which the radio device control program was stored to be used as a write area of collection data.

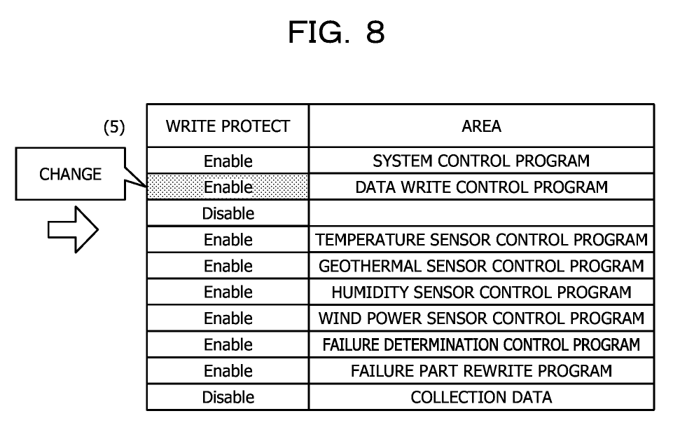

FIG. 8 is an explanatory diagram (3 of 3) illustrating an example of a change in write protection control and storage contents. As illustrated in FIG. 8(5), the microcomputer 301 instructs the write protection release circuit 307 to perform write protection of the data write control program. Thereby, the write protection of the data write control program is changed from “Disable” to “Enable”.

Also, although not illustrated in the figure, the microcomputer 301 changes the priority of the radio device control program to “High” in the memory mapping information 400. Thereby, if a failure in the other component occurs, the microcomputer 301 will not perform processing on the partial area in which the radio device control program was stored in the past, and thus it is possible to store the collection data.

Here, as described above, the memory capacity of the nonvolatile memory 305 is 200 [KB]. Among the storage area of the nonvolatile memory 305, 98% of the area is the program area, and among the storage area of the nonvolatile memory 305, 2% of the area, which is 4 [KB], is the data area. For example, if it is assumed that the size of data obtained by the various sensors 302 per one time is 10 [B], and the microcomputer 301 obtains data from the sensors 302 once per one hour, it is possible to store data forty times in the data area. Accordingly, the sensor module 201 transmits the storage data about once per 1.5 days to the base station 202 and the server 203 and releases the data area for the next collection data.

If a failure occurs with the radio device 303 in the sensor module 201, the obtained data is not released from the data area, and thus the obtained data is lost all the time after 1.5 days passes from the failure. In the present embodiment, when the program area in which the radio control program that is a failed part is stored is released, an area of 20 [KB] is expanded as the data area, and thus it becomes possible to store data for 200 times. This represents 200 times/24 hours, namely 8.3 days. Thereby, it is possible to ensure sufficient time for repairing or replacing the sensor module 201, and thus to reduce data loss.

Processing procedure of write protection release by sensor module 201

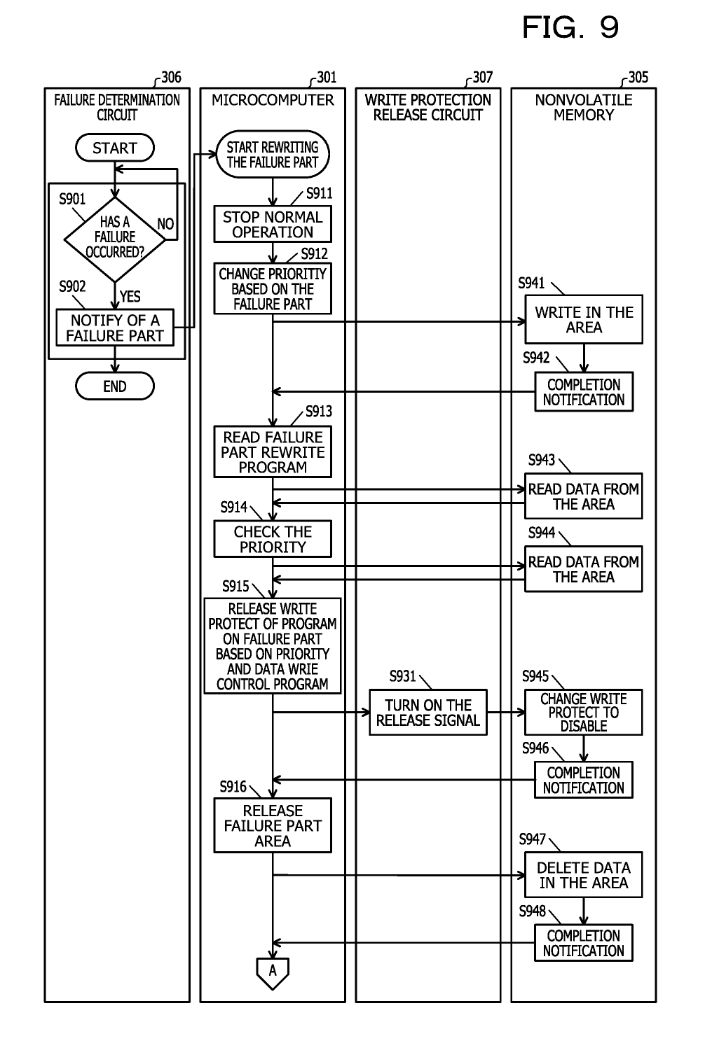

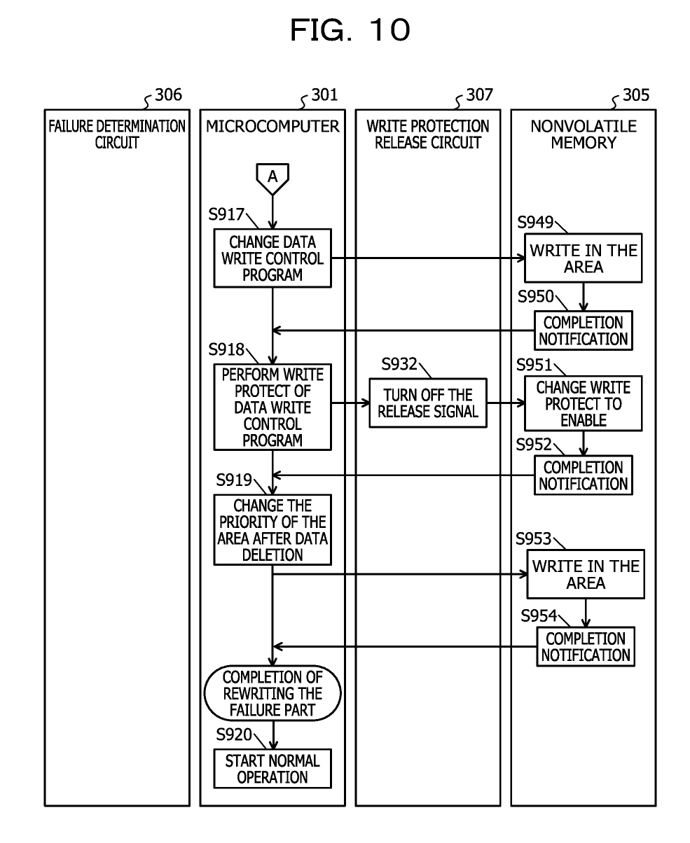

FIG. 9 and FIG. 10 are sequence charts illustrating an example of a processing procedure of write protection release by a sensor module. The failure determination circuit 306 determines whether or not a failure has occurred (step S901). If determined that a failure has occurred (Yes in step S901), the failure determination circuit 306 notifies the microcomputer 301 of a failed part (step S902), and terminates a series of processing. If determined that there is no failure (No in step S901), the failure determination circuit 306 returns to step S901. A detailed example of the failure determination processing procedure in step S901 and step S902 will be illustrated in FIG. 10.

When the microcomputer 301 receives a notification of a failed part from the failure determination circuit 306, the microcomputer 301 starts rewrite processing of the failed part. First, the microcomputer 301 stops the normal operation (step S911). Here, stopping the normal operation means suspending the execution of the system control program, for example.

The microcomputer 301 changes the priority of the program in accordance with the notified failed part (step S912). The nonvolatile memory 305 writes in the area (step S941). The nonvolatile memory 305 notifies the microcomputer 301 of the completion (step S942).

The microcomputer 301 then reads the failure rewrite program (step S913). Here, the microcomputer 301 notifies the nonvolatile memory 305 of a read instruction of the failure rewrite program. Next, the nonvolatile memory 305 reads data in the area instructed to be read, and sends the data to the microcomputer 301 (step S943). Thereby, the failure rewrite program is read.

The microcomputer 301 executes the read failure rewrite program. The microcomputer 301 then refers to the memory mapping information 400 and checks the priority of each area (step S914). Next, the nonvolatile memory 305 reads data in the area instructed to be read, and sends the data to the microcomputer 301 (step S944).

The microcomputer 301 instructs the write protection release circuit 307 to release the write protection of the failed part related program based on the priority and the data write control program (step S915). The failed part related program based on the priority is a program having the priority of “Low” in the above-described example.

The write protection release circuit 307 turns on the release signal of the write protection of the failed part related program and the data write control program (step S931). The nonvolatile memory 305 then changes the write protection of the area in which the failed part related program and the data write control program are stored to Disable (step S945). The nonvolatile memory 305 notifies the microcomputer 301 of the completion (step S946).

The microcomputer 301 instructs the nonvolatile memory 305 to release the area of the failed part related program (step S916). Next, the nonvolatile memory 305 deletes the data of the instructed area (step S947). The nonvolatile memory 305 then notifies the microcomputer 301 of the completion (step S948).

Next, the microcomputer 301 instructs to add a write destination of collection data for the data write control program (step S917). Here, for example the microcomputer 301 instructs to add the area of the failed part related program to the write destination of the collection data. The nonvolatile memory 305 writes in the area in accordance with the instruction (step S949). The nonvolatile memory 305 then notifies the microcomputer 301 of the completion (step S950).

The microcomputer 301 instructs to give the write protection to the area of the data write control program (step S918). The write protection release circuit 307 then turns off the release signal (step S932). The nonvolatile memory 305 changes the write protection of the area in which the data write control program is stored to Enable (step S951).

The nonvolatile memory 305 then notifies the microcomputer 301 of the completion (step S952). When the microcomputer 301 receives the completion notification from the nonvolatile memory 305, the microcomputer 301 changes the priority of the area from which data has been deleted to “High” (step S919). The nonvolatile memory 305 writes in the area in accordance with the instruction (step S953). The nonvolatile memory 305 then notifies the microcomputer 301 of the completion (step S954). The rewriting processing of the failed part is completed, and the normal operation is started (step S920). Here, starting the normal operation is, for example continuing to execute the system control program.

Failure determination processing procedure by the radio device 303 and the failure determination circuit 306

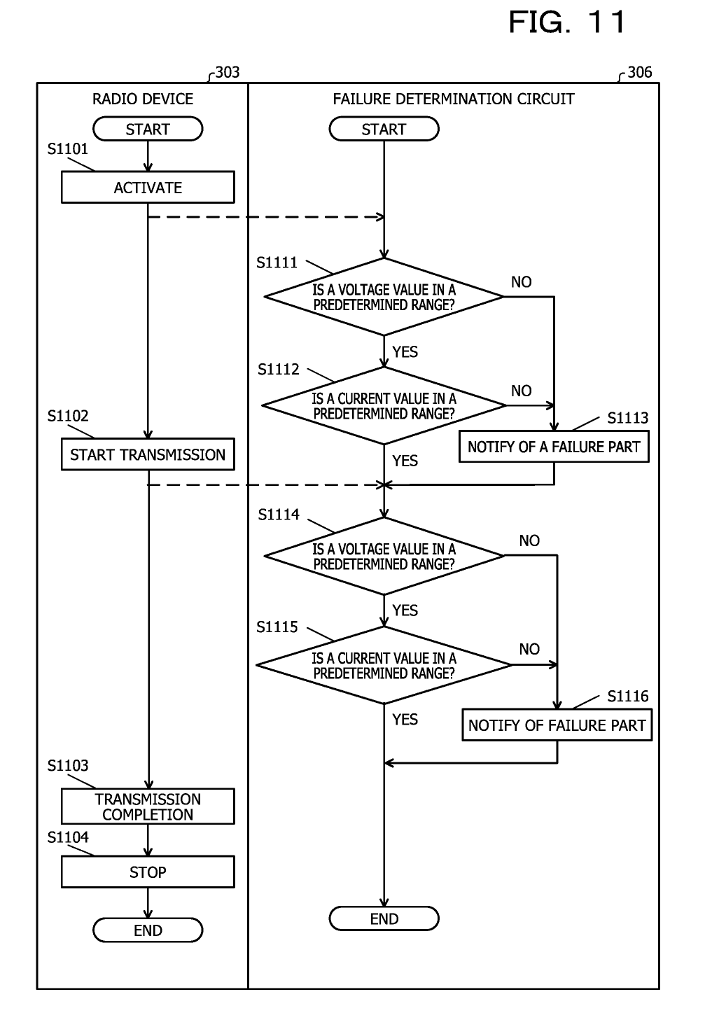

FIG. 11 is a sequence chart illustrating an example of the failure determination processing procedure by the radio device and a failure determination circuit. Here, a description will be given of an example of determination of a failure at the time of data transmission. However, the timing of the determination is not particularly limited.

When the time has come to transmit data, the radio device 303 is started (step S1101). Next, when the radio device 303 is stared, the failure determination circuit 306 determines whether or not the measured voltage value is in a predetermined range (step S1111). If the voltage value is in the predetermined range (Yes in step S1111), the failure determination circuit 306 determines whether or not the measured current value is in a predetermined range (step S1112).

If the voltage value is not in the predetermined range (No in step S1111), or the current value is not in the predetermined range (No in step S1112), the failure determination circuit 306 notifies each unit, such as the microcomputer 301, or the like of a failed part (step S1113). The failure determination circuit 306 then proceeds to step S1114. If the current value is in the predetermined range (Yes in step S1112), the failure determination circuit 306 proceeds to step S1114.

The radio device 303 starts data transmission (step S1102). When the radio device 303 starts data transmission, the failure determination circuit 306 determines whether or not the voltage value is in the predetermined range (step S1114). If determined that the voltage value is in the predetermined range (Yes in step S1114), the failure determination circuit 306 determines whether or not the current value is in the predetermined range (step S1115).

If determined that the voltage value is not in the predetermined range (No in step S1114), or if determined that the current value is not in the predetermined range (No in step S1115), the failure determination circuit 306 proceeds to step S1116. The failure determination circuit 306 notifies each unit, such as the microcomputer 301, or the like of a failed part (step S1116), and a series of processing is terminated. If determined that the current value is in the predetermined range (Yes in step S1115), the failure determination circuit 306 terminates a series of processing. The radio device 303 completes the transmission (step S1103). The radio device 303 then stops (step S1104), and a series of processing is terminated.

As described above, the terminal apparatus 100 sets an importance level for each data in the write-protected program area in advance. The terminal apparatus 100 changes the importance level based on the detected failure and the importance level and releases the write protection of the data area based on the importance level after the change. It is possible to write data to be written in the data area having the write protection released, and thus to reduce the probability of losing the data to be written.

The terminal apparatus 100 instructs the storage unit to delete data stored in the partial area after the release, and sets the partial area after the deletion to an area capable of storing the data to be written. Thereby, it is possible to expand the storage area for the data to be written.

Also, the storage unit has an area capable of storing data to be written in an area different from the program area. Thereby, the data to be written is stored in the predetermined data area, and when the data area becomes insufficient at the time of the occurrence of a failure, it is possible to the write data to be written into the expanded area.

Also, the terminal apparatus 100 includes the sensors and the data that has been sensed by the sensors is used for the data to be written. When a failure occurs in a terminal apparatus having difficulty in maintenance, such as a sensor module, or the like, it is possible to reduce the probability of losing the data to be written.

Also, the terminal apparatus 100 includes a communication unit that transmits data to be written to the outside and detects a failure in the communication unit based on a current value or a voltage value. Thereby, it is possible to simply detect a failure in the communication unit.

Also, the terminal apparatus 100 includes a communication unit that transmits data to be written to the outside and detects a failure in the communication unit based on a communication state of the communication unit. Thereby, it is possible to simply detect a failure in the communication unit.

In this regard, it is possible to realize the failure response control method described in the present embodiment by executing the failure response control program on a computer, such as a personal computer, a workstation, or the like. As described above, the failure response control program may be divided into a system control program, a failure determination control program, a failure rewrite program, and the like. The failure response control program is recorded in a computer readable recording medium, such as a nonvolatile memory, or the like, is read from the recording medium, and is executed by the computer. Also, the failure response control program may be distributed via a network, such as the Internet, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal apparatus comprising:
a memory that has a program area divided in a plurality of blocks, each blocks being set write protection; and
a processor coupled to the memory and configured to:
set a priority level of stored data to each blocks of the memory, respectively;
change the priority level to a lower level in accordance with a failure of an internal of the terminal apparatus when the failure is detected;
release the write protection in accordance with the changed priority level; and
write data that has a possibility of elimination, to the block whose write protection has released, in accordance with the failure.

2. The terminal apparatus according to claim 1,
wherein the processor is further configured to:
delete data stored in the program area where the write protection has been released, and
set the program area where the data has been deleted to a writable area.

3. The terminal apparatus according to claim 2,
wherein the memory includes the data writable area in an area different from the program area.

4. The terminal apparatus according to claim 2, further comprising
a detection unit that performs sensing the data.

5. The terminal apparatus according to claim 1, further comprising
a communication unit that transmits the data stored in the memory to the outside,
wherein when a failure of the communication unit is detected, the processor changes the priority level to the lower level in accordance with the detected failure.

6. The terminal apparatus according to claim 5, further comprising
a failure detection unit that detects a failure of the communication unit based on a current value or a voltage value of the communication unit,
wherein when the failure detection unit detects a failure of the communication unit, the processor sets the priority level to the lower level in accordance with the detected failure.

7. The terminal apparatus according to claim 5, further comprising
a failure detection unit that detects a failure of the communication unit based on a communication state of the communication unit,
wherein when the failure detection unit detects a failure of the communication unit, the processor changes the priority level to the lower level in accordance with the detected failure.

8. A failure response control method for terminal apparatus including a memory that has a program area divided in a plurality of blocks, each blocks being set write protection, and a processor coupled to the memory, comprising:
setting a priority level of stored data to each blocks of the memory, respectively;
changing the priority level to a lower level in accordance with a failure of an internal of the terminal apparatus when the failure is detected;
releasing the write protection in accordance with the changed priority level; and
writing data that has a possibility of elimination, to the block whose write protection has released, in accordance with the failure.
